(19) United States
(12) Patent Application Publication
(10) Pub. No.: US 2018/0076679 A1
(43) Pub. Date: Mar. 15, 2018

(54) STATOR FOR ROTARY ELECTRIC MACHINE

(71) Applicant: TOYOTA JIDOSHA KABUSHIKI KAISHA, Toyota-shi (JP)

(72) Inventor: Takashi MATSUMOTO, Toyota-shi (JP)

(73) Assignee: TOYOTA JIDOSHA KABUSHIKI KAISHA, Toyota-shi (JP)

(21) Appl. No.: 15/657,419

(22) Filed: Jul. 24, 2017

(30) Foreign Application Priority Data
Sep. 15, 2016 (JP) 2016-180278

(51) Int. Cl. H02K 3/487; H02K 3/34

(52) U.S. Cl. CPC H02K 3/487; H02K 3/345

(57) ABSTRACT

A stator for a rotary electric machine includes a stator core including an annular yoke, and a plurality of teeth projecting toward a radially inner side from an inner peripheral surface of the yoke; coils respectively wound around the teeth in a concentrated-winding manner; and a nonmagnetic fixing member disposed in a slot so as to fix the coils, the slot being a gap between two teeth adjacent to each other in a circumferential direction. The fixing member includes a circumferential support portion and a radial support portion, the circumferential support portion being disposed in vicinity of an inner peripheral end of the slot and having both circumferential ends fixed to respective facing surfaces of the two teeth facing each other across the slot, and the radial support portion extending to the yoke from the circumferential support portion and being fixed to the yoke.

### INCORPORATION BY REFERENCE

The disclosure of Japanese Patent Application No. 2016-180278 filed on Sep. 15, 2016 including the specification, drawings and abstract is incorporated herein by reference in its entirety.

### BACKGROUND

### 1. Technical Field

The disclosure relates to a stator for a rotary electric machine, and particularly to a stator including a fixing member made of a nonmagnetic material and provided between adjacent teeth so as to fix stator coils.

### 2. Description of Related Art

A rotary electric machine is generally configured such that a rotating field is formed by causing a desired current to flow through stator coils (hereinafter just referred to as coils) so as to rotate a rotor. It is known that adjacent teeth vibrate so as to attract each other or repel each other in a three-phase alternating current rotary electric machine in which coils are wounded in a concentrated-winding manner, or the like. That is, when a current flows through coils of the rotary electric machine, a magnetic path passing through a stator core, an air gap, and magnetic poles of a rotor is formed. Due to a structure of a stator, a magnetic flux density in the magnetic path is high in the teeth. When the magnetic path is formed, an electromagnetic force in a radial direction is generated to reduce an air gap between distal surfaces of the teeth and an outer peripheral surface of the rotor. The force in the radial direction periodically changes along with the rotation of the rotor. Further, when a three-phase alternating current is applied to the coils, the polarity of each tooth periodically changes, so that a force is applied to each tooth in a rotation direction of the rotor.

As a result, due to a vector sum of the force in the radial direction and the force in the rotation direction, adjacent teeth vibrate so as to attract each other or repel each other. The vibration in the teeth is transmitted to a yoke on an outer periphery of the teeth, and thus, vibration and noise of the rotary electric machine (electric motor) increase.

In order to solve the above problem, Japanese Patent Application Publication No. 2003-259592 (JP 2003-259592 A) discloses a stator in which a teeth-distal-end support member made of a nonmagnetic material is provided between adjacent teeth.

### SUMMARY

However, in JP 2003-259592 A, both circumferential ends of the teeth-distal-end support member having a substantially flat shape are merely fitted to the teeth on both sides thereof, and therefore, rigidity of the teeth-distal-end support member is relatively small. Accordingly, along with vibration of the teeth in a circumferential direction, the teeth-distal-end support member provided between adjacent teeth may bend relatively easily. When the teeth-distal-end support material bends, it is difficult to sufficiently restrain the vibration in the teeth.

The disclosure provides a stator in which vibration in teeth can be sufficiently restrained.

An aspect of the disclosure relates to a stator for a rotary electric machine. The stator includes: a stator core including an annular yoke, and a plurality of teeth projecting toward a radially inner side from an inner peripheral surface of the yoke; coils respectively wound around the teeth in a concentrated-winding manner; and a fixing member that is nonmagnetic and is disposed in a slot so as to fix the coils, the slot being a gap between two teeth among the plurality of teeth, and the two teeth being adjacent to each other in a circumferential direction. The fixing member includes a circumferential support portion and a radial support portion, the circumferential support portion being disposed in vicinity of an inner peripheral end of the slot and having both circumferential ends fixed to respective facing surfaces of the two teeth facing each other across the slot, and the radial support portion extending to the yoke from the circumferential support portion and being fixed to the yoke.

With the configuration, the radial support portion restrains bending of the circumferential support portion. Further, since the circumferential support portion does not bend, it is possible to restrain vibration of the stator.

In the above aspect, the radial support portion may extend to the yoke from a central part of the circumferential support portion in the circumferential direction.

With the configuration, the radial support portion extends from the central part of the circumferential support portion, the central part most easily bending in the circumferential support portion. Thus, it is possible to further restrain the bending of the circumferential support portion.

In the above aspect, the circumferential support portion may have a shape projecting toward a radially outer side.

With the configuration, it is possible to reduce drag loss between a rotor and the stator. Further, the radial support portion does not necessarily need to be bonded to the yoke, as long as the radial support portion contacts the yoke. This accordingly makes it easy to fit the fixing member.

In the above aspect, an axial length of the circumferential support portion may be substantially equal to an axial length of the stator core.

With the configuration, it is possible to further restrain circumferential deformation of the stator core over the axial direction of the stator core.

In the above aspect, each of the plurality of teeth may include recessed portions on circumferential side faces, and the both circumferential ends of the circumferential support portion may be engaged with the recessed portions.

With the configuration, it is possible to more firmly fix the circumferential support portion between the teeth adjacent to each other.

In the stator for a rotary electric machine according to the above aspect of the disclosure, the radial support portion restrains the bending of the circumferential support portion, thereby making it possible to restrain the vibration of the stator.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is an axial view of a stator of a first embodiment;

FIG. 2 is a sectional view of a part A in FIG. 1;

FIG. 3 is a view seen along a B-direction in FIG. 1;

FIG. 4 is a perspective view of an insulator of the first embodiment;

FIG. 5 is a perspective view of a fixing member of the first embodiment; and

FIG. 6 is a perspective view of a fixing member of a second embodiment.

### DETAILED DESCRIPTION OF EMBODIMENTS

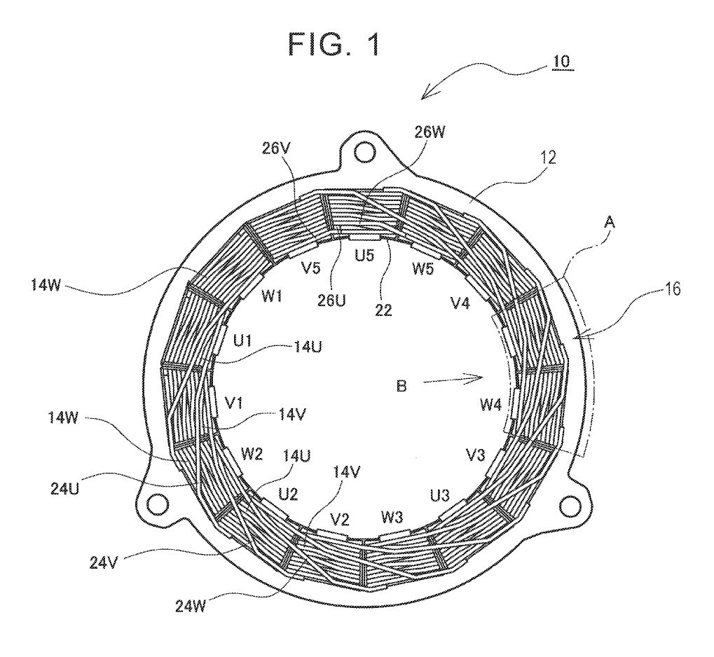

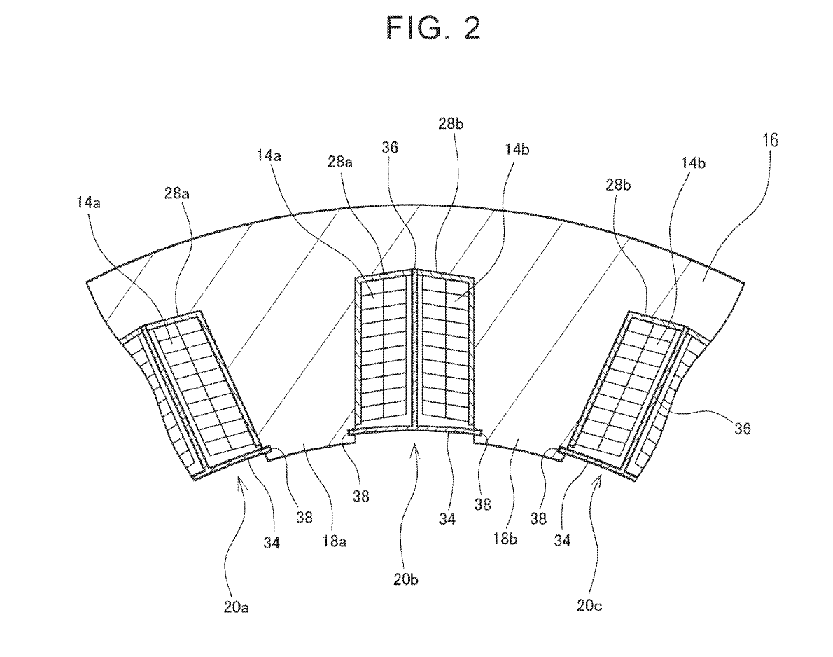

A first embodiment will be described below with reference to the drawings. FIG. 1 is an axial view of a stator 10 for a rotary electric machine and FIG. 2 is a sectional view of a part A in FIG. 1. Note that the stator 10 is used as a motor or a generator with a rotor that is not illustrated herein.

In order to make the configuration clearly understandable, various dimensions in the drawings are different from actual dimensions and some of them are different between the drawings. Further, an “axial direction,” a “radial direction,” and “a circumferential direction” in the following description all indicate an axial direction, a radial direction, and a circumferential direction of the stator 10 having a hollow cylindrical shape.

The stator 10 includes a stator core 12 and coils 14W, 14 U, 14V of three phases (hereinafter referred to as the “coil 14” without the additional alphabets when three phases are not distinguished from each other. This will also apply to other members). The stator core 12 includes an annular yoke 16, and a plurality of teeth 18 projecting toward a radially inner side (toward a rotor side (not shown)) from an inner peripheral surface of the yoke 16.

The stator core 12 is a stacked body of electromagnetic steel sheets stamped into a predetermined annular shape. However, the stator core 12 may be formed by machining steel or may be formed of magnetic powder or the like, as long as the stator core 12 is a magnetic body. Further, the stator core 12 may be formed of a plurality of partial cores arranged in an annular shape.

The teeth 18 are disposed at regular intervals in the circumferential direction. A slot 20 is formed between the teeth 18 adjacent to each other in the circumferential direction, and the slots 20 are disposed at regular intervals in the circumferential direction. Further, a recessed portion 38 extending in the axial direction is formed in the vicinity of a radial inner end of a circumferential side face of each of the teeth 18, so that a circumferential support portion 34 of the after-mentioned fixing member 22 is engaged with the recessed portion 38 (see FIG. 2).

In the first embodiment, the coil 14 is configured such that a winding wire made of a flat wire (rectangular wire) is wound in a concentrated-winding manner. A surface of the flat wire is enameled so as to ensure insulation between adjacent flat wires. The coils 14 include three phase coils, namely, a U-phase coil 14U, a V-phase coil 14V, and a W-phase coil 14W. Each of the phase coils 14 is constituted by one or more (five in the example of FIG. 1) single coils, that is, the phase coils 14 are constituted by U1 to U5, V1 to V5, and W1 to W5. The single coils U1 to U5, V1 to V5, and W1 to W5 are each formed by winding a flat wire around one tooth. In the following description, the single coils U1 to U5, V1 to V5, and W1 to W5 are referred to as U-phase single coils U1 to U5, V-phase single coils V1 to V5, and W-phase single coils W1 to W5, respectively, in accordance with their corresponding phases.

The plurality of single coils is set in the stator core 12 such that one of the U-phase single coils U1 to U5, one of the V phase-single coils V1 to V5, and one of the W-phase single coils W1 to W5 are arranged in the stated order repeatedly in the circumferential direction. Further, a single coil is connected to another single coil of the same phase, which is wound around another tooth, via a phase connection bus bar 24 formed by extending an end of the single coil. The phase connection bus bar 24 is formed by extending an inner peripheral end of each phase single coil, and is connected to an outer peripheral end of another single coil of the same phase.

A starting end of each phase coil 14 formed by connecting a plurality of single coils U1 to U5, V1 to V5, or W1 to W5 of the same phase is positioned on an outermost periphery, and an input terminal (not shown) is connected to the starting end. Further, a tail end of each phase coil 14 is positioned on an innermost periphery. The tail end of each phase coil 14 is extended to form a neutral point bus bar 24U, 24V, or 24W. The neutral point bus bars 24U, 24V, 24W of three phases are gathered at one place and joined to each other so as to form a neutral point.

Further, in order to ensure insulating properties between the coil 14 and the stator core 12, an insulator 28 made of an insulating member is disposed between the coil 14 wound around the tooth 18 and the stator core 12.

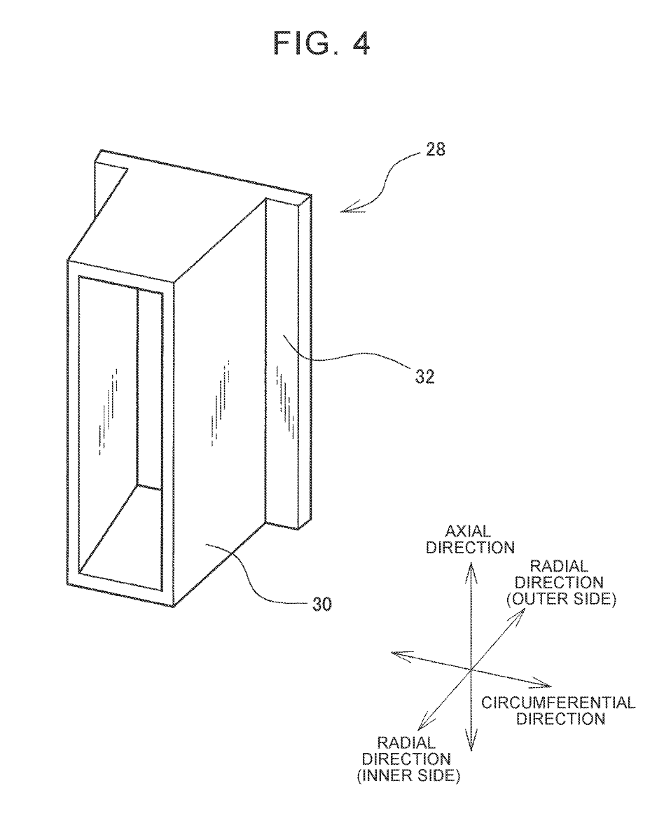

FIG. 4 illustrates the insulator 28. The insulator 28 includes a tubular portion 30 covering the tooth 18, and a flange 32 extending from a radially outer end on a lateral side of the tubular portion 30 in a stator circumferential direction. The tubular portion 30 has a substantially rectangular tubular shape that is fitted to the tooth 18 from a distal end side of the tooth 18, and its outer shape is substantially similar to an outer shape of the tooth 18. Accordingly, an axial length of the tubular portion 30 is substantially equal to an axial length of the tooth. Further, similarly to the tooth 18, a circumferential width of the tubular portion 30 is widened toward a radially outer side. A radial length of the tubular portion 30 is shorter than a radial length of the tooth 18, and a part in the vicinity of a distal end of the tooth is exposed outside without being covered with the tubular portion 30. Thus, the circumferential support portion 34 of the after-mentioned fixing member 22 is allowed to be directly engaged with the tooth 18 without making contact with the tubular portion 30.

The flange 32 is a part projecting toward both sides in the circumferential direction from a base end (a yoke-side end) of the tubular portion 30. A circumferential length of the flange 32 is smaller than ½ of a circumferential length of the yoke 16 inside the slot 20. This allows an outer distal end of a radial support portion 36 of the after-mentioned fixing member 22 to directly contact the yoke 16.

As the insulator 28, an insulator obtained by forming an insulating material such as paper or a resin sheet into the predetermined shape described with reference to FIG. 4 can be used. For example, the insulator is formed into the shape illustrated in FIG. 4 by injection molding. A plurality of resin sheet pieces may be attached to each other so as to form the predetermined shape illustrated in FIG. 4.

In the first embodiment, the insulator 28 is fitted to each tooth 18, and the coil 14 is wound around each tooth 18 such that the insulator 28 is disposed between the coil 14 and the tooth 18.

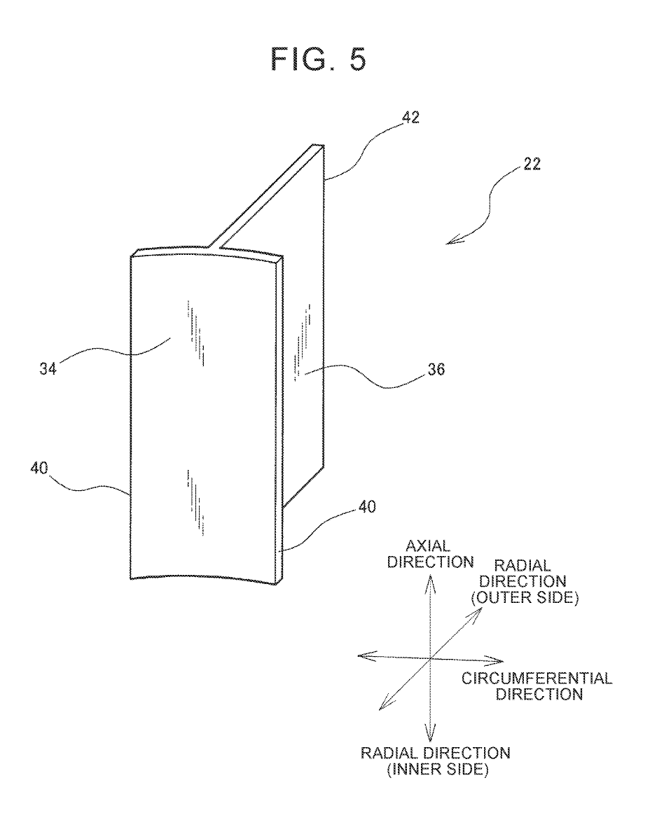

Further, in the first embodiment, each slot 20 is provided with the fixing member 22 illustrated in FIG. 5. The fixing member 22 is made of a non-magnetic material and includes the circumferential support portion 34 and the radial support portion 36. Further, the fixing member has a substantially T-shape when viewed in the axial direction.

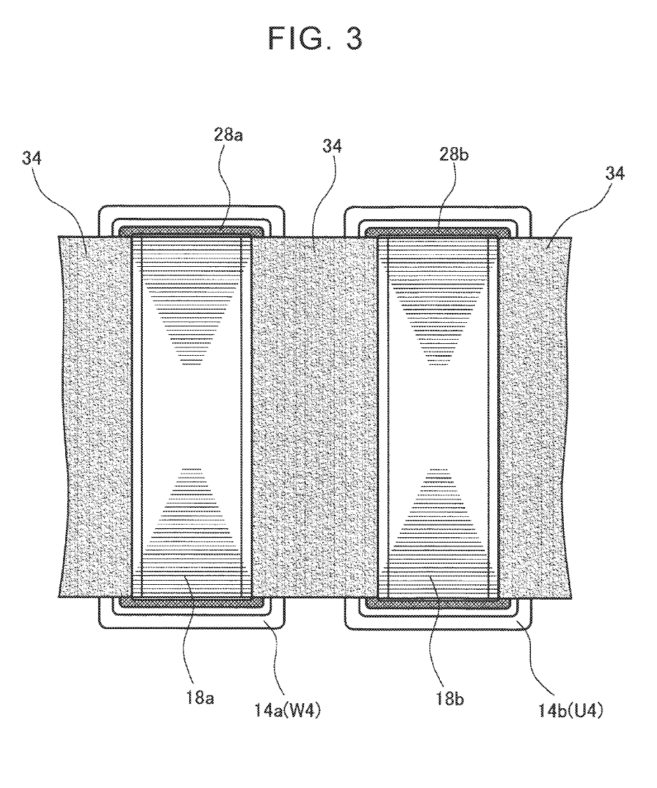

With reference to FIGS. 2 and 3, the fixing member will be described more specifically. In FIGS. 2 and 3, two teeth 18 are referred to as 18a, 18b. Further, three slots 20 are referred to as 20a, 20b, 20c. A W-phase single coil W4 and a U-phase single coil U4 wound around the two teeth 18a, 18b, respectively, are illustrated. Insulators 28a, 28b are each disposed between the stator core 12 and a corresponding one of the W-phase single coil W4 and the U-phase single coil U4.

As illustrated in FIG. 3, the circumferential support portion 34 of the fixing member 22 has a substantially plate shape that substantially covers an open end of the slot on an inner peripheral side. However, the circumferential support portion 34 is not a flat plate, and is slightly curved so as to have a substantially arc shape projecting toward a radially outer side when viewed in a stator axial direction, as illustrated in FIG. 2. Since the circumferential support portion 34 is curved as described above, it is possible to reduce drag loss between the rotor and the stator 10. Although details are described later, when the circumferential support portion is formed in a substantially arc shape projecting toward the radially outer side, the radial support portion 36 does not necessarily need to be bonded to the yoke 16 as long as the radial support portion 36 contacts the yoke 16. This accordingly makes it easy to fit the fixing member. Note that the shape of the circumferential support portion 34 may be other shapes such as a linear shape or a wave shape, for example, when viewed from the stator axial direction.

Circumferential ends 40 of the circumferential support portion 34 are engaged with recessed portions 38 formed in the teeth 18a, 18b positioned on both circumferential side faces of the slot 20b. The circumferential ends 40 of the circumferential support portion 34 disposed in each of the slots 20a, 20c are engaged with the recessed portions 38. Further, the circumferential length of the circumferential support portion 34 is longer than a circumferential width of the slot 20, and the circumferential ends 40 are pressed into the recessed portions 38, so as to prevent the circumferential support portion 34 from falling in the axial direction. By engaging the circumferential ends 40 of the circumferential support portion 34 with the recessed portions 38, it is possible to restrain radial movement of the circumferential support portion 34 (movement of the circumferential support portion 34 in the radial direction). Note that, in the first embodiment, instead of the engagement with the recessed portions 38, the circumferential support portion 34 may be fixed by use of adhesive, or projection portions may be provided in the teeth 18a, 18b so as to be engaged with recessed portions provided in the circumferential support portion 34.

A radial thickness of the circumferential support portion 34 is not limited to a specific range and may be any thickness. However, in order to avoid the contact with the rotor disposed inside the stator 10, the circumferential support portion 34 may be configured so as not to project toward a radially inner peripheral side beyond distal surfaces of the teeth 18.

The radial support portion 36 is a substantially plate-shaped part extending toward the radially outer side from a substantially central position of the circumferential support portion 34 in the circumferential direction. The radial support portion 36 is configured such that its distal end 42 contacts the yoke 16. Note that the distal end 42 may be firmly bonded by adhesive or the like. Note that the fixation (a fixed state) includes, for example, a contacting state, a bonding state, and an engaging state using recessed/projecting structures. That is, examples of “a state where the radial support portion is fixed to the yoke” include “a state where the radial support portion contacts the yoke” “a state where the radial support portion is bonded to the yoke” and “a state where the radial support portion is engaged with the yoke by use of recessed/projecting structures”.

A circumferential width of the radial support portion 36 is set to be smaller than a width of a circumferential gap formed between the coil 14U and the coil 14W inside the slot 20, such that the radial support portion 36 does not strongly make contact with the coils 14 disposed on sides of both side faces of the radial support portion 36. Further, in order to restrain displacement of the radial support portion 36 in the circumferential direction, a width of the distal end 42 of the radial support portion may be substantially the same as a width of a circumferential gap between the flange of the insulator 28a and the flange of the insulator 28b.

As has been already described, the stator 10 for the rotary electric machine in the first embodiment is configured such that the nonmagnetic fixing member 22 is provided inside the slot 20. Both ends of the circumferential support portion 34 are fixed to facing surfaces of two teeth 18 facing each other across the slot 20. Further, the distal end 42 of the radial support portion 36 contacts the yoke 16. Thus, since the fixing members 22 are provided in the respective slots 20, the distal ends of all the teeth 18 are connected to each other via the circumferential support portions 34 of the fixing members 22. Accordingly, the teeth 18 restrict each other via the fixing members 22, thereby restricting the circumferential movement of the teeth 18.

When a three-phase alternating current is applied to the coil, the rotor (not shown) inside the stator starts to rotate. Thus, an electromagnetic force is generated between magnetic poles of the rotor and the teeth 18 so as to attract each other. Due to sequential changes and the like of a strength and a direction of the electromagnetic force along with the rotation of the rotor, a force having a direction and a strength changing periodically is applied to the distal ends of the teeth 18.

In a case where the aforementioned fixing members 22 for fixing the movement of the teeth 18 are not provided, the teeth 18 vibrate in the circumferential direction due to the force applied to the teeth 18, namely, so-called “annular vibration” is caused.

In order to prevent the annular vibration, it is conceivable that the stator 10 should be subjected to resin molding. However, when the resin molding is performed, a part such as the yoke 16, which has a low effect for restraining the vibrations of the teeth 18, needs to be also subjected to resin molding. This increases a manufacturing cost.

In view of this, instead of the resin molding, it is suggested that a flat-plate member for connecting the distal ends of the teeth 18 to each other should be provided so as to restrict the movement of the teeth 18. That is, it is suggested that a member such as a fixing member including only the circumferential support portion 34 without the radial support portion 36 should be provided. However, the flat-plate member configured such that the circumferential ends 40 of the circumferential support portion 34 are merely fitted to the teeth 18 provided on both side thereof has relatively small rigidity. Therefore, along with the vibration of the teeth 18 in the circumferential direction, the flat-plate member provided between adjacent teeth may bend relatively easily. When the flat-plate member bends, it is difficult to sufficiently restrain the vibration in the teeth 18.

In the stator 10 of the first embodiment, the fixing member 22 including the radial support portion 36 in addition to the circumferential support portion 34 is provided in each slot 20, so as to restrict the movement of the teeth 18. Thus, the circumferential support portion 34 can hardly bend, thereby making it possible to further restrain the vibration of the stator 10. The following describes this point more specifically.

As has been already described, when a three-phase alternating current is applied to the coils 14, a force (an electromagnetic force) having a direction and a strength changing periodically is applied to the teeth 18, and the teeth 18 are to vibrate in the circumferential direction. When the teeth 18 adjacent to each other are to approach each other upon receipt of the force, forces in circumferential compression directions are applied to the circumferential support portion 34 of the fixing member 22 disposed therebetween.

When the forces in the circumferential compression directions are applied to the circumferential support portion 34, the circumferential support portion 34 is to bend toward the radially outer side because the circumferential support portion 34 is curved so as to have a substantially arc shape projecting toward the radially outer side. A center of the circumferential support portion 34 is to move toward the radially outer side.

However, since the radial support portion 36 extending from the central part of the circumferential support portion 34 functions as a support bar (a sustaining rod) between the yoke 16 and the circumferential support portion 34, the circumferential support portion 34 hardly bends.

Note that the circumferential support portion 34 fixed by press-fitting between adjacent teeth cannot restrict the movement of the adjacent teeth to separate from each other. However, in a case where the adjacent teeth separate from each other, e.g., in a case where one tooth separates from a tooth adjacent thereto on the left side, the one tooth needs to approach a tooth on the right side, the movement to approach the tooth on the right side is restricted by a fixing member positioned on the right side. Accordingly, as long as all the slots are provided with the fixing members, it is possible to restrict both the movement of adjacent teeth to approach each other and the movement thereof to separate from each other. As a result, it is possible to restrain the teeth 18 from vibrating in the circumferential direction. Thus, since the stator 10 of the first embodiment includes the fixing members 22, it is possible to increase its annular rigidity. Since the annular rigidity of the stator 10 increases, it is possible to restrain the displacement of the coils 14 wound around the teeth 18 due to the vibration of the stator 10. As a result, fixing reliability of the coils 14 fixed by being wound around the teeth 18 can be also improved.

Further, in the first embodiment, the circumferential central part of the circumferential support portion 34 bends most easily. However, the radial support portion 36 extends from the circumferential central part. Thus, it is possible to more effectively restrain the bending of the circumferential support portion 34.

Further, it is possible to restrain the coils 14, by the radial support portion 36, from making contact with each other inside the slot 20.

Further, it is possible to eliminate the necessity of performing the resin molding for the purpose of the restraint of the vibration caused in the stator 10 and the insulation between the coils 14. This makes it possible to reduce a manufacturing cost.

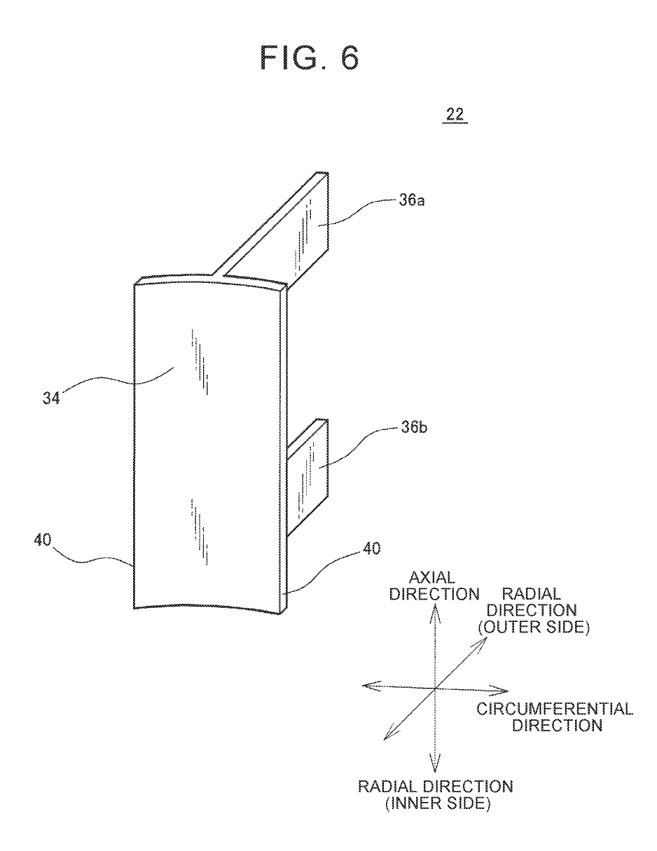

Next a second embodiment will be described with reference to FIG. 6. FIG. 6 is a perspective view of a fixing member provided in each slot 20 of a stator 10 in the second embodiment.

Similarly to the first embodiment, in the second embodiment, the fixing member includes a circumferential support portion 34 and radial support portions 36, and is fixed inside the slot 20. However, unlike the first embodiment, two radial support portions 36a, 36b extending from the circumferential support portion 34 toward a radially outer side are arranged in an axial direction, and an axial length of each of the radial support portions 36a, 36b is shorter than an axial length of the circumferential support portion 34.

Similarly to the first embodiment, the fixing member 22 in the second embodiment is configured such that a circumferential end 40 of the circumferential support portion 34 is fixed to the circumferential side face of the tooth 18 facing the circumferential support portion 34. Further, distal ends of the radial support portions 36a, 36b are also set to contact the yoke 16.

As has been already described, since the two radial support portions 36a, 36b extending from the circumferential support portion 34 toward the radially outer side are arranged in the axial direction, it is possible to reduce the weight of the fixing member 22 as compared to the first embodiment. Further, similarly to the first embodiment, it is possible to restrain the circumferential support portion 34, by the radial support portions 36a, 36b, from bending. Further, the radial support portions 36a, 36b may be arranged in the circumferential direction inside the circumferential support portion 34.

Further, the fixing member may be configured such that a plurality of fixing members 22 is disposed in the axial direction inside one slot 20. For example, the axial length of the fixing member 22 may be set to be less than ⅓ of the axial length of the stator core 12, such that three fixing members are arranged in the axial direction. With this arrangement, the opening of the slot 20 on the inner peripheral side is only partially covered with the circumferential support portions 34 of the fixing members 22, when the slot 20 is viewed in the radial direction. The slot 20 communicates with the inner peripheral side of the stator core 12. As a result, similarly to the first embodiment, it is possible to restrain the vibration of the stator 10, and further, it is possible to restrain heat from the coils 14 from staying in a space surrounded by a wall surface of the slot 20 and the circumferential support portions 34, as compared to the first embodiment.

In the first and second embodiments, the circumferential support portion 34 and the radial support portion 36 of the fixing member 22 are directly fixed to the stator core 12, but another member, e.g., the insulator 28 or the like, may be provided between the fixing member 22 and the stator core 12, for example.

Further, in the first and second embodiments, the circumferential support portion 34 of the fixing member 22 has a shape projecting toward the radially outer side, but may have a shape projecting toward the radially inner side. However, in this case, the radial support portion 36 extending from the circumferential support portion 34 needs to be directly or indirectly bonded to the yoke 16 or directly or indirectly engaged with the yoke by use of recessed/projecting structures or the like, instead of simply contacting the yoke 16, for the following reason. The circumferential support portion 34 is curved so as to have a substantially arc shape projecting toward the radially inner side, and therefore, when forces in the circumferential compression directions are applied to the circumferential support portion 34, the circumferential support portion 34 bends toward the radially inner side, so that the center of the circumferential support portion 34 is to move toward the radially inner side. Then, the radial support portion 36 is to move in a direction to separate from the yoke in the radial direction. When the radial support portion 36 is bonded to the yoke 16, it is possible to restrain the radial support portion 36 from moving in the direction to separate from the yoke 16. That is, since the radial support portion 36 extending from the central part of the circumferential support portion 34 functions as a support bar between the yoke 16 and the circumferential support portion 34, the circumferential support portion 34 hardly bends.

Further, in the first and second embodiments, the circumferential support portion 34 of the fixing member 22 is engaged with the recessed portions 38 formed in the teeth 18 so as to be fixed to the teeth 18. However, instead of the recessed portions 38, projection portions projecting in the circumferential direction may be provided in the distal ends of the teeth 18 such that the circumferential support portion 34 is fixed to the teeth 18. That is, the circumferential ends 40 of the circumferential support portion 34 may be directly or indirectly brought into contact with the circumferential side faces of the teeth 18, and further, the projection portions projecting in the circumferential direction so as to restrict the movement of the fixing member 22 toward the radially outer side may be provided in the teeth 18 such that the circumferential support portion 34 is fixed to the teeth 18.

What is claimed is:

1. A stator for a rotary electric machine, the stator comprising:
a stator core including an annular yoke, and a plurality of teeth projecting toward a radially inner side from an inner peripheral surface of the yoke;
coils respectively wound around the teeth in a concentrated-winding manner; and
a fixing member that is nonmagnetic and is disposed in a slot so as to fix the coils, the slot being a gap between two teeth among the plurality of teeth, and the two teeth being adjacent to each other in a circumferential direction, wherein
the fixing member includes a circumferential support portion and a radial support portion, the circumferential support portion being disposed in vicinity of an inner peripheral end of the slot and having both circumferential ends fixed to respective facing surfaces of the two teeth facing each other across the slot, and the radial support portion extending to the yoke from the circumferential support portion and being fixed to the yoke.

2. The stator according to claim 1, wherein the radial support portion extends to the yoke from a central part of the circumferential support portion in the circumferential direction.

3. The stator according to claim 1, wherein the circumferential support portion has a shape projecting toward a radially outer side.

4. The stator according to claim 1, wherein an axial length of the circumferential support portion is substantially equal to an axial length of the stator core.

5. The stator according to claim 1, wherein each of the plurality of teeth includes recessed portions on circumferential side faces, and the both circumferential ends of the circumferential support portion are engaged with the recessed portions.

6. The stator according to claim 1, wherein a plurality of the fixing members is provided such that the fixing members are respectively disposed in all the slots in the stator.

7. The stator according to claim 1, wherein a plurality of the radial support portions extends to the yoke from the circumferential support portion.
